(19) United States
(12) Patent Application Publication
(10) Pub. No.: US 2010/0128937 A1
(43) Pub. Date: May 27, 2010

(54) MULTI-IMAGE ACQUISITION APPARATUS

(75) Inventors: Jang-Hee YOO, Daejeon (KR); Jong-Gook KO, Daejeon (KR); Ki Young MOON, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon (KR)

(21) Appl. No.: 12/623,559

(22) Filed: Nov. 23, 2009

(30) Foreign Application Priority Data
Nov. 24, 2008 (KR) 10-2008-0116625

(51) Int. Cl. G06K 9/00; H04N 7/18

(52) U.S. Cl. 382/117; 348/78; 382/118; 348/240.3; 348/E07.085

(57) ABSTRACT

A multi-image acquisition apparatus for use in a biometrics system includes a light splitting filter for reflecting or transmitting multi-image lights representing an image of a target subject provided along an identical light path into different bands; a first image sensor for imaging an iris area by capturing a fraction of the multi-image light which has been transmitted through the light splitting filter; and a second image sensor for imaging a facial area by capturing a fraction of the multi-image light which has been reflected from the light splitting filter. The apparatus further includes a control module for controlling the first image sensor and the second image sensor and providing the images obtained by the first sensor and second sensor for image recognition.

### CROSS-REFERENCE(S) TO RELATED APPLICATION

The present invention claims priority of Korean Patent Application No. 10-2008-0116625, filed on Nov. 24, 2008, which is incorporated herein by reference.

### FIELD OF THE INVENTION

The present invention relates to an image acquisition apparatus for a multi-modal biometrics system, and, in particular, to the image acquisition apparatus for acquiring facial and iris images for use in a multi-modal biometrics system.

### BACKGROUND OF THE INVENTION

Currently, the field of biometrics is diverging into multi-modal biometrics, long distance biometrics, and user-friendly image acquisition technologies. In particular, the fields of facial and iris recognition are evolving into a multi-modal facial and iris biometric technique because two pieces of biometric information can be acquired from a single facial image and fields of different biometrics can be complemented each other. In particular, an iris recognition technology shows best performance in biometrics.

However, a biometrics system has the disadvantage of a low utilization due to an inconvenient interfacing between a user and the system in iris image acquisition and limited compatibility with facial recognition.

In order to simultaneously acquire facial and iris images, a facial image acquisition apparatus and an iris image acquisition apparatus are separately required. The facial image acquisition apparatus and the iris image acquisition apparatus are provided with respective cameras, and adjust incident angles of their corresponding cameras arranged at upper and lower locations to capture facial and iris images, respectively.

Meanwhile, the technology using the facial image acquisition camera and the iris image acquisition camera may be susceptible to an error due to differences in incident angles and phases and in the photographing areas.

Furthermore, the conventional iris image acquisition camera uses a cold mirror positioned in front of a camera lens and imaging an incident image thereon to enable a user to directly check the location of the eye to be imaged from a short distance, e.g., about 40 cm.

However, although a cold mirror is useful to check an incident image over a short distance, appropriate training is requisite for the convenient use of the cold mirror. Accordingly, it is necessary to develop a user-friendly iris and facial image acquisition technique capable of simultaneously acquiring iris and facial images from a long distance with greater efficiency.

### SUMMARY OF THE INVENTION

The present invention provides a multi-image acquisition apparatus capable of simultaneously acquiring facial and iris images from a relatively long distance while minimizing error attributable to a phase difference occurring when capturing facial and iris images along a same light path.

In accordance with an aspect of the present invention, there is provided a multi-image acquisition apparatus for use in a biometrics system including a light splitting filter for reflecting or transmitting multi-image lights representing an image of a target subject provided along an identical light path into different bands; a first image sensor for imaging an iris area by capturing a fraction of the multi-image light which has been transmitted through the light splitting filter; a second image sensor for imaging a facial area by capturing a fraction of the multi-image light which has been reflected from the light splitting filter; and a control module for controlling the first sensor and the second sensor and providing the images obtained by the first sensor and second sensor for image recognition.

According to the present invention, images of a facial region and an iris area can be simultaneously acquired using a single camera apparatus and an iris image can be acquired from a long distance (identical to the distance from which a facial image is captured) without requiring a cold mirror. Furthermore, the present invention allows an image of a subject to pass along the same one path of the camera apparatus, thereby minimizing the occurrence rate of error attributable to a phase difference which may occur when facial and iris images are captured using two existing facial recognition and iris recognition cameras. Furthermore, the present invention is configured such that a telescopic lens is added in front of the camera apparatus, so that facial track/recognition and iris recognition can be performed from a long distance and efforts to bring a user's eye to a location near a guidance area within the cold mirror of the camera apparatus to perform iris recognition can be reduced, with the result that it is expected that the usability of the facial and iris image acquisition/recognition system can be considerably increased.

### BRIEF DESCRIPTION OF THE DRAWINGS

The objects and features of the present invention will become apparent from the following description of preferred embodiments given in conjunction with the accompanying drawings, in which:

FIG. 1 is a schematic diagram showing the configuration of a multi-image acquisition apparatus capable of simultaneously acquiring facial and iris images from a single incident light;

FIG. 2 is a detailed block diagram showing the control module of the multi-image acquisition apparatus shown in FIG. 1;

FIG. 3 is a diagram showing the connection between the multi-image acquisition apparatus and a multi-image recognition apparatus;

FIG. 4 is a block diagram showing an example of the internal construction of the multi-image recognition apparatus;

FIG. 5 is a diagram showing an example of facial and iris images acquired from a single input image using the multi-image acquisition apparatus; and

FIG. 6 is a flowchart showing an example of controlling the multi-image acquisition and recognition of the biometrics system according to the present embodiment.

### DETAILED DESCRIPTION OF THE EMBODIMENTS

Hereinafter, embodiments of the present invention will be described in detail with reference to the accompanying drawings, which form a part hereof.

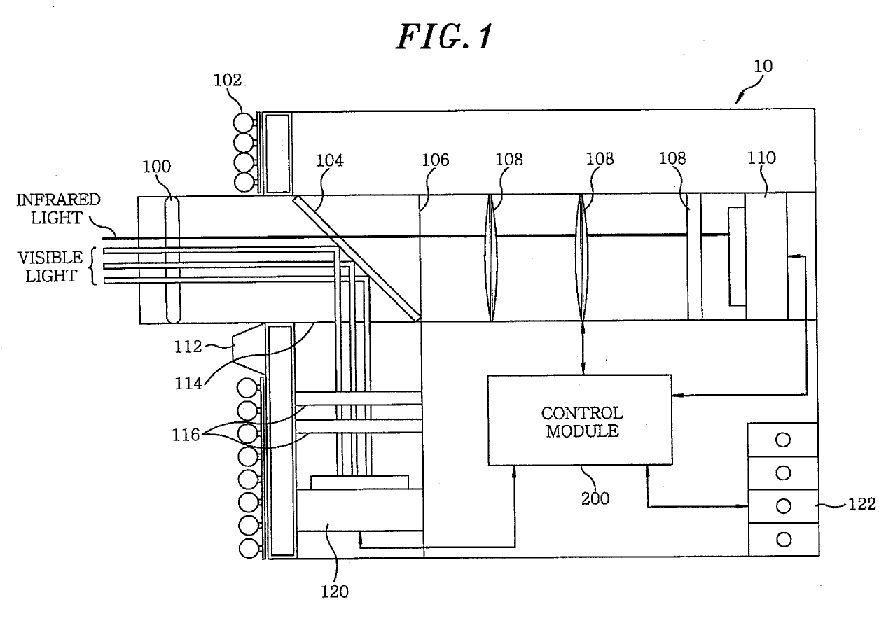

FIG. 1 is a schematic diagram showing a configuration of a multi-image acquisition apparatus 10 for use in a multi-modal biometrics system for simultaneously acquiring both facial and iris images from a single incident light. The multi-image acquisition apparatus 10 includes a focusing lens 100, an infrared illuminator array 102, a light splitting filter 104, an infrared filter 106, a zoom lens group 108, an iris image sensor 110, a distance measurement sensor 112, a UV filter 114, an objective lens group 116, a facial image sensor 120, a control module 200, and an external interface terminal 122.

First, the focusing lens 100 is used to improve parallel light for incident light of a target subject for image acquisition along a single light path. In the drawing, the incident light includes infrared rays represented by a thin solid line, and visible rays represented by thick solid lines. In general, an image for facial recognition uses the visible ray band, while an image for iris recognition uses the infrared band.

The infrared illuminator array 102 is arranged in the front surface of the multi-image acquisition apparatus and used to capture an iris image along with the iris image camera 110. The infrared illuminator array 102 emits infrared rays in a specific wavelength band ranging, e.g., from 750 nm to 850 nm. The infrared rays reach the target subject, and are then reflected to the multi-image acquisition apparatus 10 as multi-image light representing the target subject. Intensity of the infrared illuminator array 102 for iris image capture needs to be strengthened in proportion to a distance between the target subject and the multi-image acquisition apparatus.

The light splitting filter 104 is used for reflecting and transmitting the multi-image light to different bands. For example, a beam splitter or a dichroic mirror may be used as the light splitting filter 104. For the application of the beam splitter, it is preferable to design the beam splitter to reflect the multi-image light in the entire visible ray band on the basis of a specific wavelength and to transmit infrared light over a specific band. For the application of the dichroic mirror, it is preferable to design the dichroic mirror to have an infrared filtering function.

The infrared filter 106 is provided for a case where a beam splitter is used as the light splitting filter 104, and is requisite for the acquisition of a more desirable iris image in the iris image sensor 110 to which light in the infrared band is provided. Here, for the purpose of iris recognition from the light in the infrared band, the infrared filter 106 may include an infrared filter capable of passing infrared rays in a band ranging from 750 nm to 850 nm or a long pass infrared filter capable of passing infrared rays in a band above approximately 750 nm.

In order to recognize the iris, a diameter of an iris area needs to be wider than, e.g., 150 pixels and therefore, it is necessary to enlarge and capture an eye area in a facial region. The zoom lens group 108 is employed to guarantee such image quality of the enlarged and captured eye area, and the focusing control of the zoom lens group 108 under the control of the control module 200 allows to enlarge and capture an iris image.

The iris image sensor 110 serves to obtain an iris image from a fraction of the multi-image light. For example, a high-resolution image sensor, more preferably, a low-speed and high-resolution monochrome CCD/CMOS sensor may be used as the iris image sensor.

A lens with a low field of depth may be used to acquire the iris image. In this case, minute focusing adjustment using a distance measurement sensor 112 is required.

Meanwhile, the UV filter 114 may be provided to improve the facial image in a visible band reflected from the light splitting filter 104. Further, the objective lens group 116 is provided to improve the facial image and acquire the facial image of a specific size.

The facial image sensor 120 is used for facial image acquisition from a fraction of the multi-image light. For example, a high-speed image sensor, more preferably, a high-speed and low-resolution CCD/CMOS sensor may be used as the facial image sensor 120.

The control module 200 functions to control the zoom lens group 108, the iris image sensor 110 and the facial image sensor 120 and provides facial and iris images acquired by the image sensor 110 and the facial image sensor 120 to an image recognition apparatus 300 (which will be described later) through the external interfacial terminal 122. Additionally, the control module 200 enables power to be supplied to the multi-image acquisition apparatus 10 through the external interface terminal 122. Further, In order to acquire an iris image through the enlargement of an iris area in a facial image, the control module 200 performs a synchronization process for the acquisition of an eye area from a facial region.

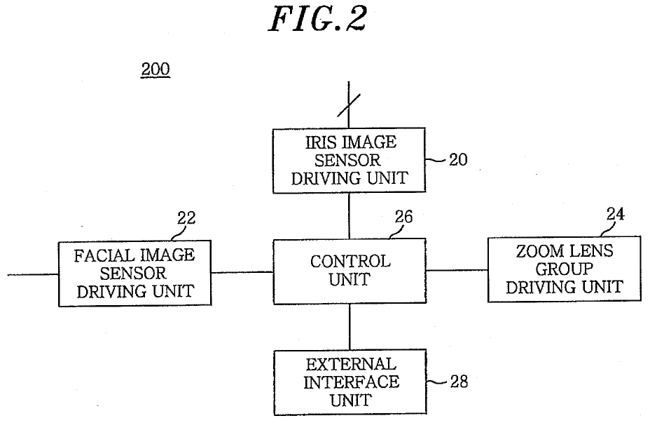

Hereinafter, the operation of the control module 200 is described in detail with reference to FIG. 2.

FIG. 2 is a detailed block diagram showing the control module 200 of the multi-image acquisition apparatus 10 shown in FIG. 1. The control module 200 includes an iris image sensor driving unit 20 for driving the iris image sensor 110 to acquire the iris image, a facial image sensor driving unit 22 for driving the facial image sensor 120 to acquire the facial image, a zoom lens group driving unit 24 for controlling a focusing operation of the zoom lens group 108, a control unit 26 for controlling the overall operations of iris image sensor driving unit 20, the facial image sensor driving unit 22 and the zoom lens group driving unit 24, and an external interface unit 28 for connecting the external interface terminal 122 and the control unit 26 to each other.

Here, when a facial region enlargement command (to enlarge an eye part for the purpose of iris image acquisition) is received from the multi-image recognition apparatus 300 through the external interface terminal 122, the control unit 26 controls the zoom lens group driving unit 24 so that the zoom lens group 108 is focused. Furthermore, when an iris image and/or facial image acquisition command is received from the image recognition apparatus 300 through the external interface terminal 122, the control unit 26 controls the iris image sensor driving unit 20 and/or the facial image sensor driving unit 22 to acquire the iris and/or facial image and to provide the acquired iris and facial image to the image recognition apparatus 300 through the external interface terminal 122.

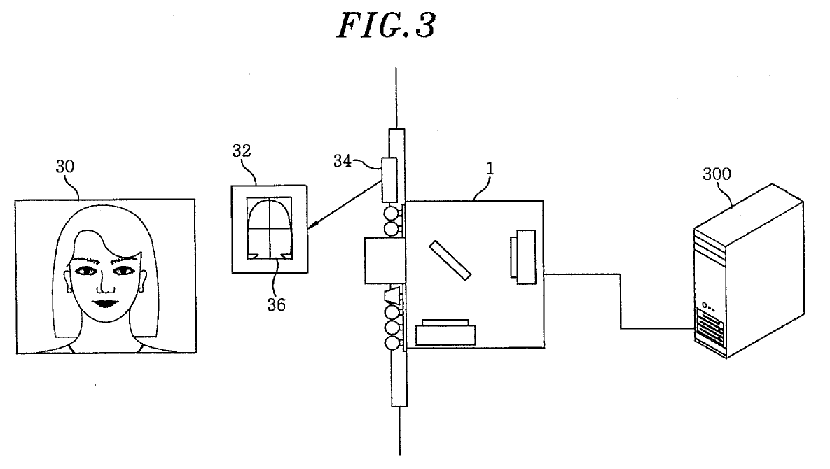

FIG. 3 is an example of diagram showing a connection between the image acquisition device 1 and the multi-image recognition device 300 in a multi-modal biometrics system.

As can be seen from FIG. 3, an indicator 34 is attached to the front of the multi-image acquisition apparatus 10 and is used to accurately locate a facial image 30 in order to efficiently acquire facial and iris images. The indicator 34 may be implemented with a liquid crystal display (LCD), an organic light emitting diode (OLED) or the like. If necessary, the indicator 34 may be configured to issue voices.

For example, in case where an LCD is used as the indicator 34, a reference screen 32 having an area of interest 36 may be employed so that a facial region of the facial image 30 to be located on the LCD has been located in the area of interest.

A degree of freedom for a facial image is flexible. However, in order to accurate capture an eye area, a facial region needs to be accurately located when a resolution of a camera module is low or it is necessary to enlarge the eye area at high magnification.

The multi-image acquisition apparatus 10 are connected to the image recognition apparatus 300. The image recognition apparatus 300 functions to control the indicator 34 and the multi-image acquisition apparatus 10 and, also, to recognize or authenticate the iris and facial images acquired by the multi-image acquisition apparatus 10 by using an appropriate iris and facial recognition software.

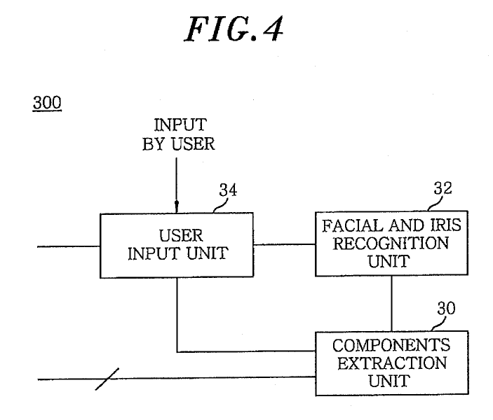

FIG. 4 is a block diagram of the image recognition apparatus 300. The image recognition apparatus 300 includes a component extraction unit 30 for extracting components of the iris and face of the subject in captured images provided by the multi-image acquisition apparatus, a facial and iris recognition unit 32 for recognizing the iris and face using the extracted components, and a user input unit 34 for applying a user input signal in conjunction with the iris and facial recognition software.

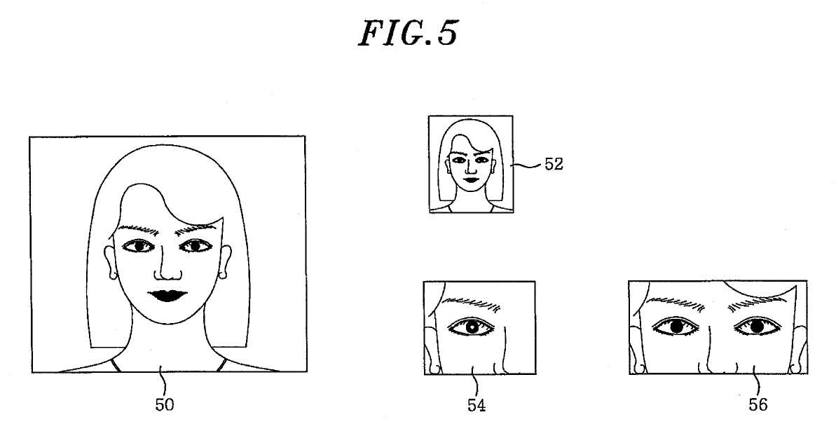

FIG. 5 is a diagram showing an example of facial and iris images acquired from a single input image using the image acquisition apparatus.

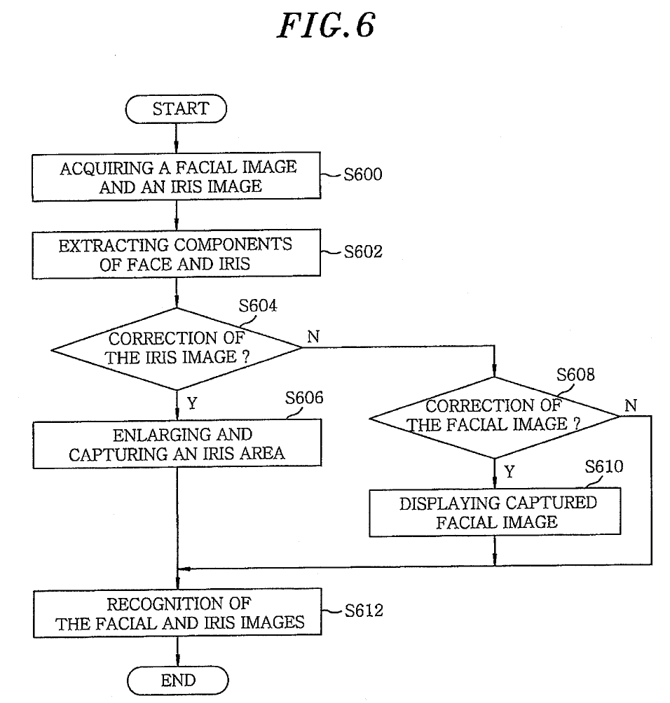

From a face to be imaged 50, a facial region 52 may be imaged by the facial recognition camera 120 and a single eye region 54 or an eye region of two eyes 56 may be imaged by the iris image sensor 110 depending on resolution. FIG. 6 is a flowchart showing a method of the multi-image acquisition and recognition by the multi-image acquisition apparatus and in accordance with the present embodiment.

First, a target subject to be imaged is provided to the iris image sensor 110 and the facial image sensor 120 where facial and iris regions are captured to acquire a facial image and an iris image, respectively at step S600.

The facial and iris images are then provided to the image recognition apparatus 300 through the external interface terminal 122, and the components of the face and iris of the subject are extracted from the facial and iris images by the component extraction unit 30 at step S602. The extracted components of the face and iris of the subject are then provided to the facial and iris recognition unit 32.

At this time, if the correction of the iris image has been requested by the user input unit 34 in the image recognition apparatus 300 at step S604, the image recognition apparatus 300 provides a corresponding correction request signal to the control unit 26 in the multi-image acquisition apparatus, and the control unit 26 controls the zoom lens group driving unit 24 so that it focuses the zoom lens group 108, thereby enlarging and capturing an iris area 54 or 56, at step S606.

Further, if the user input unit 34 of the image recognition apparatus 300 requests the correction of the facial image at step S608, the image recognition apparatus 300 provides a corresponding correction request signal to the indicator 34 attached to the front of the image acquisition apparatus, and the indicator 34 displays the captured facial image 52 to rearrange the face region at step S610.

Finally, at step S612 the facial and iris recognition unit 32 recognizes the facial and iris images having separate and corrected results.

While the invention has been shown and described with respect to the preferred embodiments, it will be understood by those skilled in the art that various changes and modifications may be made without departing from the spirit and scope of the invention as defined in the following claims.

What is claimed is:

1. A multi-image acquisition apparatus for use in a biometrics system, comprising:
a light splitting filter for reflecting or transmitting multi-image lights representing an image of a target subject provided along an identical light path into different bands;
a first image sensor for imaging an iris area by capturing a fraction of the multi-image light which has been transmitted through the light splitting filter;
a second image sensor for imaging a facial area by capturing a fraction of the multi-image light which has been reflected from the light splitting filter; and
a control module for controlling the first sensor and the second sensor and providing the images obtained by the first sensor and second sensor for image recognition.

2. The multi-image acquisition apparatus of claim 1, wherein the fraction of the multi-image light transmitted through the light splitting filter is an infrared light.

3. The multi-image acquisition apparatus of claim 1, the fraction of the multi-image light reflected from the light splitting filter is a visible light.

4. The multi-image acquisition apparatus of claim 1, wherein the image captured by the first image sensor is an image to be used for iris recognition.

5. The multi-image acquisition apparatus of claim 1, wherein the image captured by the second image sensor is an image to be used for face recognition.

6. The multi-image acquisition apparatus of claim 1, wherein the light splitting filter includes a beam splitter.

7. The multi-image acquisition apparatus of claim 1, wherein the light splitting filter includes a dichroic mirror.

8. The multi-image acquisition apparatus of claim 7, wherein the dichroic mirror incorporates therein an infrared filtering function.

9. The multi-image acquisition apparatus of claim 1, further comprising:
a zoom lens group for enlarging the image obtained by the first image sensor under the control of the control module.

10. The multi-image acquisition apparatus of claim 1, further comprising:
a distance measurement sensor for minutely adjusting a distance to the iris to be imaged by the first image sensor.

11. The multi-image acquisition apparatus of claim 2, further comprising:
an illuminator array for generating the infrared rays to the target subject.

12. The multi-image acquisition apparatus of claim 1, further comprising:
an indicator for displaying a guidance area for a facial to be imaged by the second image sensor.
